(19) United States
(12) Patent Application Publication
(10) Pub. No.: US 2009/0084207 A1
(43) Pub. Date: Apr. 2, 2009

(54) SPLIT SHAFT FOR HIGH POWER DIESEL ENGINE

(75) Inventors: Venkatesh Raman, Bangalore (IN); John P. Zachariah, Madhya Pradesh (IN)

Correspondence Address: FLETCHER YODER P.C., 7915 FM 1960 RD. WEST, SUITE 330, HOUSTON, TX, 77070, US

(73) Assignee: General Electric Company, Schenectady, NY (US)

(21) Appl. No.: 11/864,588

(22) Filed: Sep. 28, 2007

(51) Int. Cl. F16H 3/08

(52) U.S. Cl. 74/325

(57) ABSTRACT

An idler shaft assembly is disclosed suitable for internal combustion engines, such as the heavy duty engines. The assembly may transmit power between a crank shaft and a cam shaft. The assembly includes a hollow shaft which can be interference fit within a small idler gear, with a large idler being mounted on a shoulder of the small idler gear. Idler hubs on either side of the hollow shaft are centered with respect to the idler shaft and are held firmly in place by fasteners that extend through one of the hubs and the hollow shaft, and are threaded into the other hub. Lubrication may be provided by an internal reservoir formed in the hollow shaft, and oil passages in fluid communication with this reservoir that extend to journal bearings mounted between the idler hubs and the support structure for the overall assembly.

### BACKGROUND

The present invention relates generally to internal combustion engines, and more particularly to a novel idler shaft assembly for such engines.

Various designs of internal combustion engines have been proposed and many designs have been placed into service. In general, such engines include a series of pistons that are reciprocally mounted in an engine block and that drive a crank shaft in rotation in response to combustion of fuel and oxidant in the engine cylinders. Current engine designs that utilize this general scheme include gasoline engines, diesel engines, and similar engines designed to work on other fuels. In addition to turning the crank shaft, large engines include internal power transmission drive trains for servicing the engine itself. By way of example, certain internal combustion engines utilize gearing to transfer power from the crank shaft to drive a cam shaft used to open and close valving for the cylinders. Other internal power transmission drive trains may regulate injection timing of fuel, although certain engines utilize electronic controls for this purpose.

In one specific internal drive train for internal combustions engines, multiple stages of gearing may be employed between the crank shaft to which the pistons are connected, and the cam shaft that controls valve opening and closing. Because this function is essential to the normal operation of the engine, the gearing, support bearings, support structures, and other associated components are subjected to a great number of cycles during their useful life, and must be extremely reliable. At the same time, there is always a drive toward structures that are relatively straightforward in their design and manufacture, and that can be produced and installed in efficient manufacturing steps. There is a continuing need for improvement in such designs. At present, there is a need for a design that can be used in heavy duty engines and that employs a limited number of parts that can be assembled in a highly reliable manner, offering an extended useful life.

### BRIEF DESCRIPTION

The present invention provides a novel idler shaft assembly designed to respond to such needs. The assembly may be used in a wide range of engine applications, but is particularly well-suited for transferring power between a crank shaft and a cam shaft in a heavy duty engine. The assembly allows for the crank shaft to drive the cam shaft in normal operation, but also may transfer power from the cam shaft back to the crank shaft during certain periods of operation. The assembly may include two gears, a large idler gear and a small idler gear. The idler shaft assembly itself supports these gears, with the small idler gear being interference fit on a hollow shaft of the assembly. The large idler gear may be interference fit on the small idler gear. Idler hubs are mounted on either side of the hollow shaft, and these are drawn into tight engagement with the idler shaft by means of fasteners. The idler hubs effectively center the hollow shaft, and thereby the gears, with respect to support structures, such as left and right crankcase supports. Rotation of the assembly is facilitated by bearings interposed between the crankcase supports and the idler hubs. The entire structure may be lubricated by means of a lubricant that can flow through the hollow shaft and passages in the idler hubs to the bearings.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an engine having an idler shaft assembly interposed between a crank shaft and a cam shaft in accordance with aspects of the invention;

FIG. 2 is a sectional view through an exemplary idler shaft assembly mounted in an engine of the type represented diagrammatically in FIG. 1, in accordance with aspects of the invention;

FIG. 3 is a perspective sectional view of the idler shaft assembly of FIG. 2 illustrating its various components;

FIG. 4 is a similar sectional view of one of the idler hubs on one side of the assembly;

FIG. 5 is a sectional view of the hollow shaft of the assembly;

FIG. 6 is sectional view of a second idler hub of the assembly;

FIG. 7 is a graphical representation of loads at various points in the idler shaft assembly, noting reaction in the bearings when the crank shaft is driving the cam shaft; and

FIG. 7 is a similar graphical representation of reaction forces at the bearings when the cam shaft is driving the crank shaft.

### DETAILED DESCRIPTION

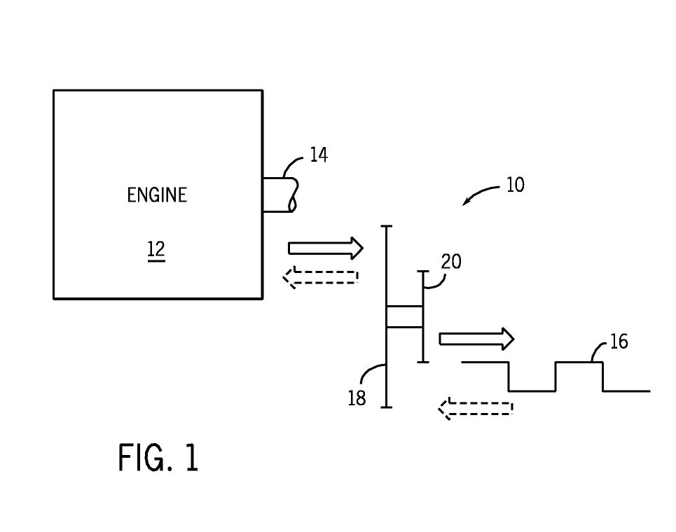

Turning now to the drawings, and referring first to FIG. 1, a diagrammatical representation is provided of an idler shaft assembly 10 used in conjunction with an engine 12. The engine may be any type of internal combustion engine, but in a present context may be a heavy duty diesel engine, such as those used for locomotives, ships and boats, off-road tractors, tractor-trailers, engine-driven generators, and so forth. As will be appreciated by those skilled in the art, the engine 12 is forced and maintained in motion by combination of fuel with an oxidant, that is combusted in internal cylinders of the engine (not shown) to force a crank shaft 14 to rotate. Useful work may be drawn from this shaft, such as to drive a generator, a propulsion gear train with wheels, propellers, and so forth. The idler shaft assembly 10 serves to transmit torque between the crank shaft 14 and a cam shaft 16. The cam shaft 16 is designed to open and close valving (not shown) for the cylinders of the engine in a manner generally known in the art. The idler shaft assembly 10 generally includes a large idler gear 18 rigidly coupled to a small idler gear 20. Idler gear 18 is mechanically coupled to the engine, while small idler gear 20 is mechanically coupled to the cam shaft by means of intermeshing gearing, not represented in the figures.

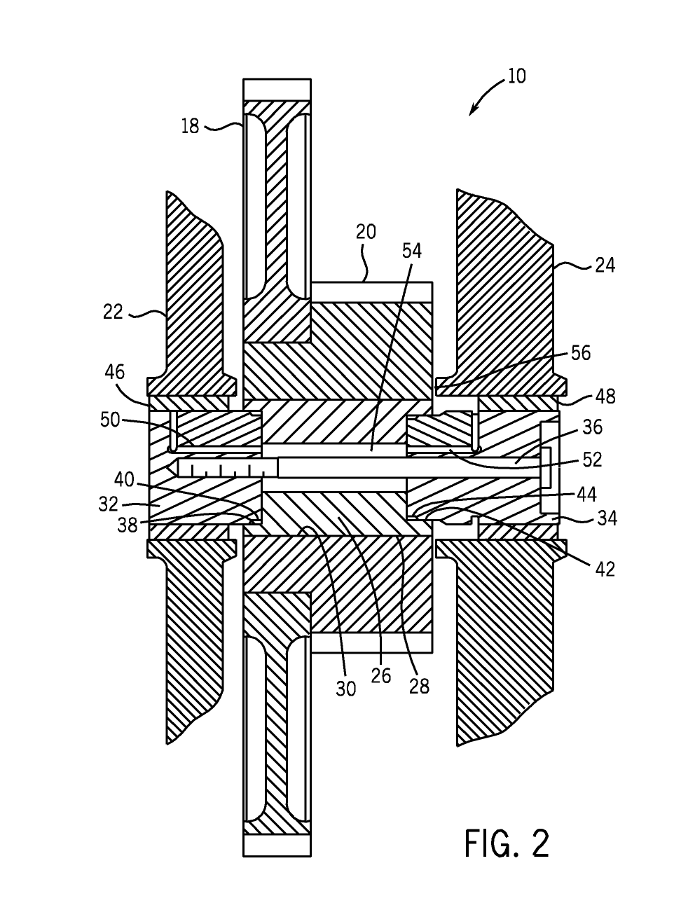

A more detailed sectional view of an exemplary embodiment of the idler shaft assembly 10 is shown in FIG. 2. As illustrated in FIG. 2, the idler shaft assembly 10 is supported by walls of the crankcase, with left and right walls being partially shown in section in FIG. 2, and designated generally by reference numerals 22 and 24, respectively. The idler shaft assembly itself includes a hollow shaft 26. The hollow shaft 26 may be made of any suitable material, such as steel. The shaft 26 has an outer diameter 28 that is dimensioned to be interference fit within an inner diameter 30 of the small idler gear 20. These components may be fit together by any known interference fit technique, such as by heating or cooling these components (i.e., shrink fitting), press fitting, and so forth. Once fitted within the small idler gear 20, the hollow shaft 26 will be rigidly fixed with respect to this gear, and the two will rotate together. Similarly, the large idler gear 18 may be press or interference fit on an extension of the small idler gear 20, and rotate rigidly with this gear. As will be appreciated by those skilled in the art, anti-rotation features, such as keys, may be used to ensure that these components rotate as a group.

The hollow shaft 26, itself, is centered and held in place rotationally by idler hubs 32 and 34. The idler hubs are mounted on either side of the hollow shaft and are self-centered in recesses of the shaft. In particular, as illustrated in FIG. 2, a first idler hub 32 is mounted on an alternator side of the assembly, while an idler hub 34 is mounted on the crankcase side. Bolts 36 are received through these hubs and through the hollow shaft 26 and are placed in tension to tightly bind these three components to one another, centering both the hollow shaft 26 and the idler gears between the supports for the assembly. The hollow shaft 26 has a central recess 38 on the side of idler hub 32 that receives a pilot surface 40 extending from the hub. Similarly, on an opposite side of the hollow shaft, the shaft 26 has a central recess 42 designed to receive a pilot surface 44 of the idler hub 34.

In the illustrated embodiment, the entire idler shaft assembly is rotationally mounted by means of journal bearings 46 and 48 secured between the idler hubs 32 and 34 and their corresponding crankcase supports, respectively. The journals may be made of any suitable material, including those materials commonly used for journal bearings in the art. The bearings are lubricated by means of oil passages, and an internal oil reservoir that may be integral to the hollow shaft. In the embodiment illustrated in the figures, an internal oil passage 50 is drilled into the alternator side idler hub 32, by means of internally intersecting bore holes. Similarly, an internal oil passage 52 is formed in the crankcase side idler hub 34. The hollow nature of the shaft 26 allows this shaft to form a lubricant reservoir in fluid communication with the oil passages 50 and 52. During operation oil is drawn from the crankcase and will ultimately fill, at least partially, the central oil reservoir 54 formed in the hollow shaft 26, and be communicated through the oil passages 50 and 52 to lubricate the journal bearings. Close clearances, as indicated at reference numeral 56, exists between the idler shaft assembly (such as at the level of the small idler gear 20) and the crankcase supports. This clearance promotes the retention of lubricant, and aids in maintaining the entire assembly centered between the crankcase supports. In a present embodiment, one or both sides of the assembly may be covered by a removable cover (not shown) fitted over the respective hub.

It may be noted that the design illustrated in FIG. 2 effectively moves the bearings 46 and 48 as far outboard as possible on the idler shaft assembly. As compared to heretofore known designs, it is believed that this approach effectively reduces bearing pressures and reaction forces by extending the moment arm at which applied forces are reacted to. Moreover, the illustrated design reduces the need to removably support the idler gears on the idler shaft, as is done in certain known designs, by effectively rigidly mounting the hollow shaft of the idler shaft assembly within the small idler gear.

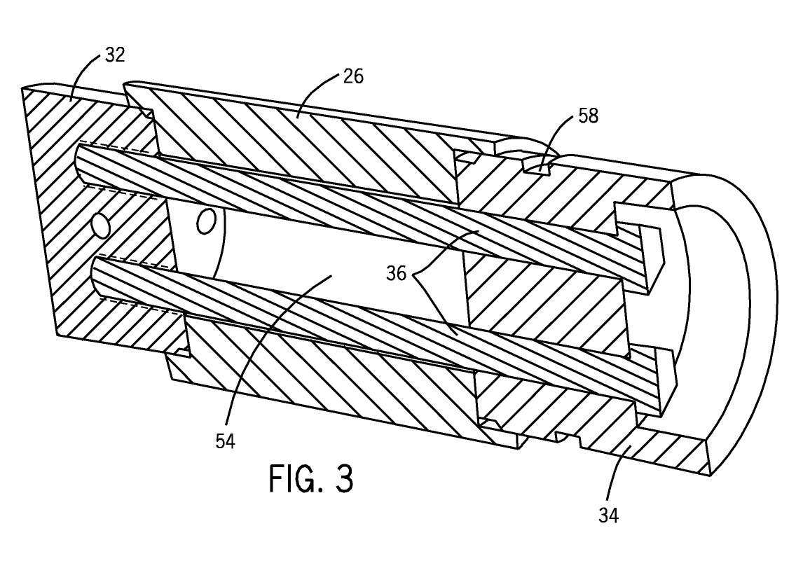

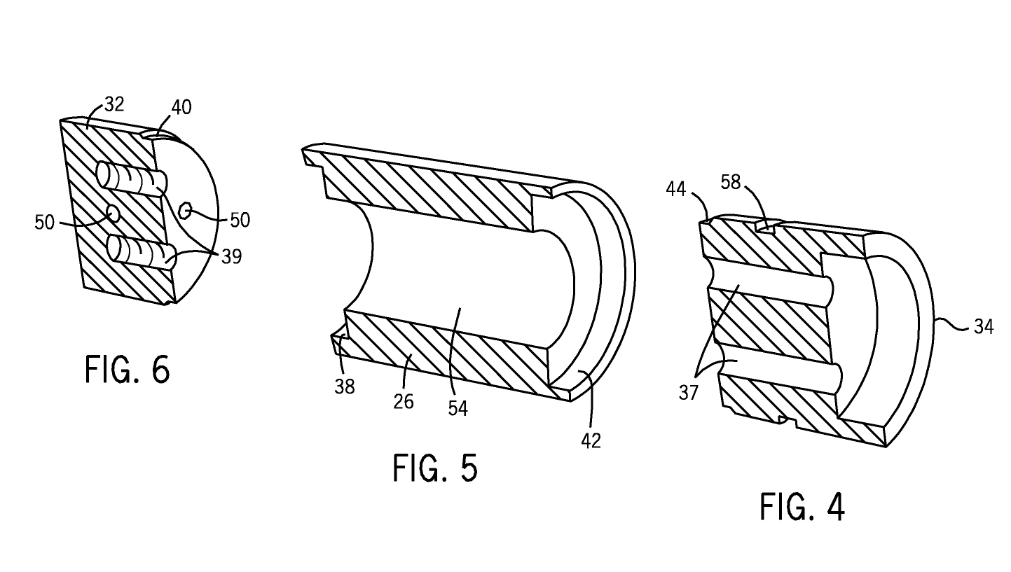

FIG. 3 illustrates the foregoing arrangement in a perspective section, while FIGS. 4, 5 and 6 illustrate the components removed from one another in a composite exploded view. As shown in FIG. 3, in a present embodiment, the hollow shaft 26 is rigidly mounted to the idler hubs 32 and 34 by a pair of bolts. These bolts may be passed directly through the hub 34, as well as through the oil reservoir 54 formed in the hollow shaft 26, and are threaded into the idler hub 32. An oil groove 58 is formed in hub 34 to promote the distribution of oil or other lubricant within the assembly and between the parts.

As best illustrated in FIG. 4, with the bolts removed, two apertures or bores 37 are shown as formed in the hub 34 to receive the bolts shown in the previous figures. Similarly, threaded apertures 39 are formed in the complimentary hub 32, as shown in FIG. 6. Also shown in FIG. 4 is the pilot surface 44 on hub 34 which fits snuggly within the recess of 42 formed in the hollow shaft 26 (see FIG. 5). In a similar manner, recess 38 is illustrated in FIG. 5 that mates with pilot surface 40 of hub 32, shown in FIG. 6.

Also shown in FIG. 6 is the oil passage 50 formed of two intersecting bores drilled in the hub 32. As noted above, similar passages are formed in hub 34, but are not visible in the view of FIG. 4 due to the section selected. These passages of hub 34 will generally be in communication with groove 58.

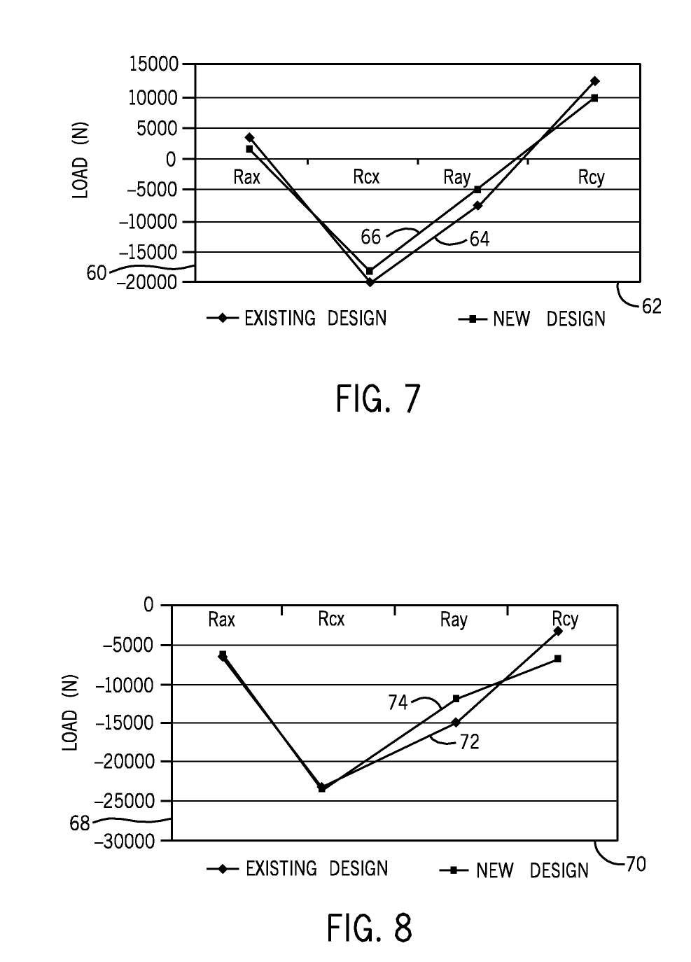

It has been found that with the configuration of the idler shaft assembly described above, partially owing to the positioning of the idler gears on hollow shaft, and to the arrangement of the hubs on either side of the shaft that support the outboard general bearings, reaction forces can be reduced as compared to heretofore known designs. FIGS. 7 and 8 illustrate estimates of such forces in the current design (labeled “new design” and in previous designs, labeled “existing design”). FIG. 7 illustrates loading in Newtons, as indicated by axis 60, along points of the assembly, as denoted by axis 62. The points illustrated in FIG. 7 indicate reaction points at the large idler gear side, as indicated by the notation “a”, and at the small idler gear side, denoted “c”. The notation “x” and “y” in FIG. 7 indicate the vertical and horizontal directions. The trace 64 of FIG. 7 indicates that substantially greater reaction forces must be resisted by the bearings in existing designs as compared to the new design, as shown in the trace designated by reference numeral 66 in FIG. 7. Again, this is in large part due to the placement of the bearings on the idler hubs outboard of the hollow shaft of the assembly.

When the cam shaft is transmitting torque to the crank shaft, on the other hand, as indicated in FIG. 8, reaction forces are again reduced as compared to existing designs. Specifically, the load, indicated by along axis 68, distributed at positions along the assembly as indicated by axis 70, is anticipated to be reduced, as indicated by the difference between trace 72 for existing and designs, and trace 74 for the inventive arrangement.

A number of advantages are believed to flow from the inventive design described above. For example, the mounting of the small idler gear directly on the hollow shaft aids in the manufacturing process, and in the accurate location of the gear on the shaft, and avoids arrangements in which the gear itself must be sandwiched between support assemblies. Similarly, the mounting of the large idler gear on the small idler gear aids in securing these components to one another, and ensures that they will rotate together, along with the hollow shaft as a united assembly. Moreover, the mounting assembly, the bearing assembly, and the disposition of the hollow shaft and small idler gear between the crankcase supports avoids the need for thrust bearings. Similarly, there is no special need for axially aligning the hub with respect to other components, once the hub is securely mounted in the small idler gear. Also, the inventive arrangement allows for mounting bearings on the hubs, rather than on the gears themselves, avoiding the need to perform special machining steps on the gears, which themselves are more complex and expensive to manufacture and machine. The same is true of the bolt arrangement, which allows for machining (e.g., drilling and tapping) of the hubs themselves, rather than the gears as is currently performed in certain known arrangements. The threading of the hub may allow, for example, for avoiding damage to the gears that could occur if threads formed in the gears are damaged or stripped during service or due t over-torquing of fasteners threaded directly into the gears.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An idler gear assembly comprising:
a hollow shaft configured to be interference fit within a small idler gear;
a first hub fit to a first side of the hollow shaft;
a second hub fit to a second side of the hollow shaft opposite the first side;
means for drawing the first hub, the second hub and the hollow shaft into engagement whereby the hubs and shaft rotate as a single unit in service; and
bearings fitted to outer diameters of the first and second hubs for facilitating rotation of the assembly with respect to a support structure.

2. The assembly of claim 1, comprising small idler gear interference fit about the hollow shaft.

3. The assembly of claim 2, comprising a large idle gear interference fit about a shoulder of the small idler gear.

4. The assembly of claim 1, wherein the hubs each include a lubricant passageway in fluid communication with an interior volume formed in the hollow shaft, the lubricant passageways communicating lubricant from the interior volume to the bearings during operation.

5. The assembly of claim 1, wherein the means for drawing the hubs and hollow shaft into engagement includes a threaded fastener extending through the first hub and threaded into a threaded bore of the second hub.

6. The assembly of claim 1, wherein the hollow shaft has a first recess in the first side thereof and a second recess in the second side thereof, and wherein the first and second hubs have extensions received within the first and second recesses, respectively.

7. The assembly of claim 1, wherein the bearings are journal bearings configured to be received between the hubs and walls of an engine crankcase.

8. The assembly of claim 7, wherein the means for drawing the hubs and hollow shaft into engagement includes a pair of fasteners accessible through an opening in one of the crankcase walls.

9. An idler gear assembly comprising:
a small idler gear;
a large idler gear fitted to a shoulder of the small idler gear;
a hollow shaft configured to be fit within the small idler gear;
a first hub fit to a first side of the hollow shaft;
a second hub fit to a second side of the hollow shaft opposite the first side;
means for drawing the first hub, the second hub and the hollow shaft into engagement whereby the gears, the hubs and the hollow shaft rotate as a single unit in service; and
bearings fitted to outer diameters of the first and second hubs for facilitating rotation of the assembly with respect to a support structure.

10. The assembly of claim 9, wherein the small idler gear is interference fit about the hollow shaft.

11. The assembly of claim 9, wherein the large idle gear is interference fit about the shoulder of the small idler gear.

12. The assembly of claim 9, wherein the hubs each include a lubricant passageway in fluid communication with an interior volume formed in the hollow shaft, the lubricant passageways communicating lubricant from the interior volume to the bearings during operation.

13. The assembly of claim 9, wherein the means for drawing the hubs and hollow shaft into engagement includes a threaded fastener extending through the first hub and threaded into a threaded bore of the second hub.

14. The assembly of claim 9, wherein the hollow shaft has a first recess in the first side thereof and a second recess in the second side thereof, and wherein the first and second hubs have extensions received within the first and second recesses, respectively.

15. The assembly of claim 9, wherein the bearings are journal bearings configured to be received between the hubs and walls of an engine crankcase.

16. The assembly of claim 15, wherein the means for drawing the hubs and hollow shaft into engagement includes a pair of fasteners accessible through an opening in one of the crankcase walls.

17. An idler gear assembly comprising:
a small idler gear;
a large idler gear interference fit to a shoulder of the small idler gear;
a hollow shaft interference fit within the small idler gear;
a first hub fit to a first side of the hollow shaft;
a second hub fit to a second side of the hollow shaft opposite the first side;
a threaded fastener extending through the first hub and through the hollow shaft, and threaded into a bore of the second hub whereby the gears, the hubs and the hollow shaft rotate as a single unit in service; and
bearings fitted to outer diameters of the first and second hubs for facilitating rotation of the assembly with respect to a support structure.

18. The assembly of claim 17, wherein the hubs each include a lubricant passageway in fluid communication with an interior volume formed in the hollow shaft, the lubricant passageways communicating lubricant from the interior volume to the bearings during operation.

19. The assembly of claim 17, wherein the hollow shaft has a first recess in the first side thereof and a second recess in the second side thereof, and wherein the first and second hubs have extensions received within the first and second recesses, respectively.

20. The assembly of claim 17, wherein the bearings are journal bearings configured to be received between the hubs and walls of an engine crankcase.
